(19) United States
(12) Patent Application Publication
(10) Pub. No.: US 2019/0171983 A1
(43) Pub. Date: Jun. 6, 2019

(54) SYSTEMS AND METHODS FOR GENERATING AND UTILIZING CUSTOMIZED DYNAMIC MODELS IN AN AUTOMATED PLATFORM FOR CONTROLLING HAZARDOUS CONDITIONS AND SITE WORKFLOWS

(71) Applicant: VITRALOGY IP, LLC, Bohemia, NY (US)

(72) Inventor: Philip Thomas D'Amelia, Nesconset, NY (US)

(21) Appl. No.: 16/209,696

(22) Filed: Dec. 4, 2018

Related U.S. Application Data
(60) Provisional application No. 62/594,881, filed on Dec. 5, 2017.

(51) Int. Cl. G06Q 10/06; C02F 1/00

(52) U.S. Cl. CPC G06Q 10/0633; C02F 1/00; G06Q 10/06311

(57) ABSTRACT

This disclosure relates to techniques for controlling hazardous conditions and workflows at various sites, such as residential or commercial buildings. A logistics platform can include functionality for monitoring the hazardous conditions, which can include hazardous biological or chemical conditions, associated with the sites. Dynamic models can be generated for controlling workflows related to managing the hazardous conditions. Inputs can be received at the logistics platform from monitoring equipment that includes sensors that enable real-time tracking of the hazardous conditions. Inputs can additionally, or alternatively, be received over a network from electronic devices. The execution of the workflows can be controlled using the dynamic model and the inputs received.

### CROSS-REFERENCE TO RELATED APPLICATIONS

The present application claims priority to U.S. Provisional Patent Application No. 62/594,881 filed on Dec. 5, 2017. The contents of the aforementioned application are herein incorporated by reference in its entirety.

### TECHNICAL FIELD

The present disclosure is directed to an automated platform for handling hazardous conditions (e.g., hazardous biological conditions and chemical conditions) and workflows at sites. In certain embodiments, the platform includes tools for generating dynamic models for use with automating logistics operations, integrating the dynamic models into software applications utilized by various stakeholders associated with managing or implementing the logistics operations, and tracking and managing the progress of the logistics operations using the integrated dynamic models.

### BACKGROUND

Managing logistical operations often involves detailed coordination of operations involving numerous persons, facilities, and/or supplies. These operations are typically required to be scheduled and executed precisely within small time frames. Even the smallest of mishaps can cause an entire workflow to breakdown. In many cases, the breakdown of a workflow can result in loss of customers, fines to businesses, and/or harm to individuals.

Various industries and businesses are faced with obstacles associated with managing complex logistical operations. For example, in the transportation industry, logistics operations are typically aimed at ensuring coordinated movement of goods or persons from an origin to a destination. In the military services, logistics operations are utilized to maintain supply lines and to ensure that resources are transported to where they are needed by military personnel. Proper management of logistical operations also plays a large role in manufacturing industries, inventory control services, and various functions performed by businesses, organizations, and governments.

Property management is another area that is facing increasingly complex logistics operations. Property managers are typically responsible for managing sites (e.g., residential buildings, commercial buildings, industrial buildings, facilities, or other types of property locations) and monitoring various conditions at those sites. Monitoring and managing multiple sites can be labor-intensive and requires significant resources to be devoted to scheduling, managing, and following up with vendors to perform various tasks. Such activities are particularly challenging in view of complex regulatory climates that require the property managers to undertake various actions to ensure compliance with applicable regulations and laws (e.g., environmental regulations that may require compliance with applicable state, federal, and local environmental regulations and laws). In addition to understanding and keeping up with the current obligations that are imposed by these regulations, property managers are faced with the daunting task of coordinating and scheduling activities among multiple vendors and other parties to perform tasks in connection with compliance measures. Such activities are resource-intensive and prone to significant errors when performed manually or when relying mainly on persons to manage and execute the tasks. These errors can be particularly disruptive and costly as fines may be imposed, licenses can be revoked, and individuals can be harmed.

One important role that property managers hold involves ensuring compliance with regulations directed to preventing or curing hazardous conditions (e.g., biological/chemical hazards) at the various sites. For example, the New York City Department of Health and Mental Hygiene has recently enacted environmental regulations that pertain to treating water stored in water or cooling towers for legionella and other biological agents. In order to comply with these regulations, property managers are required to undertake different types of tasks (e.g., submitting water samples for laboratory testing, cleaning and treating water with biocides, cleaning water tower structures, draining and filling the tower structures, and performing maintenance on the tower structures and associated water systems). In addition to being complex, these tasks require coordination among many different parties (e.g., service providers for performing the tasks, individuals at the sites, and governmental compliance personnel). Moreover, many of these tasks are required to be completed within precise time frames. The regulations impose very specific time limits for performing such tasks, and failure to perform the tasks in the required time frames can result in heavy fines.

Property managers are also tasked with handling integrated facilities management (IFM) operations. These operations can include tasks associated with interior property services (e.g., building maintenance, plumbing services, electrical services, HVAC services, computer services, and/or cleaning services); exterior property services (e.g., construction projects, snow removal, and landscaping services); safety conditions (e.g., related to safety measures associated with protection against fires, earthquakes, tornadoes, or inclement weather); and other types of tasks. In certain cases, the property managers are also required to oversee compliance with property-related governmental regulations (e.g., housing regulations, zoning regulations, and/or regulations pertaining to landlords).

Each site has a unique set of logistical challenges and requirements. The logistical challenges of each site may vary based on the equipment that is available at the facility and the activities that are currently ongoing at the sites. For example, certain sites may have multiple water towers that require monitoring and maintenance services, while other sites have one cooling tower or no cooling towers. Likewise, certain sites may routinely utilize snow removal services (e.g., in cold weather climates), while other sites routinely utilize landscaping services (e.g., in warmer climates). The logistical challenges of each site may also vary based on how tasks are allocated and carried out at the sites. For example, certain sites may outsource some or all of the tasks associated with cleaning water towers to third-party service providers (also referred to herein as “vendors”), while other sites utilize in-house personnel or employees to handle such tasks. Similarly, certain sites may choose to outsource some or all of the interior and exterior property services to third-party vendors or service providers, while other sites utilize in-house personnel or employees to handle such tasks.

Because the logistical challenges for each site can vary greatly, there is no centralized solution or single platform that can adequately assist the property managers with managing the tasks at various sites. A platform that is configured to provide assistance at one particular site is typically inadequate and unsatisfactory for providing assistance at a majority of other sites. Therefore, to accommodate various sites, a customized platform would have to be designed for each of the sites to account for the specific and varying needs of the sites. Because developing customized solutions for each site can be very expensive in terms of labor and costs, property managers have not done so and, instead, have largely chosen to handle property management tasks manually. As mentioned above, handling such tasks manually can result in significant errors and runs a high risk of incurring fines and providing inadequate service at the sites, which can be detrimental to the health of individuals at the sites.

In view of the foregoing, there is a need for a platform that is able to generate customized models that can be tailored to complex logistical workflows at a plurality of sites that have varying needs, and which can be integrated into software solutions that assist property managers or other individuals and organizations with handling ever-changing local conditions at the sites and automating management of the logistical workflows at the sites.

### BRIEF DESCRIPTION OF DRAWINGS

The inventive principles are illustrated in the figures of the accompanying drawings, which are meant to be exemplary and not limiting, and in which:

FIG. 1 is a block diagram of a system according to certain embodiments;

FIG. 2 is an exemplary node diagram for a dynamic model that is utilized to automate workflows according to certain embodiments;

FIG. 3 is an exemplary interface for defining and adding nodes to be inserted into a node diagram for a dynamic model according to certain embodiments;

FIG. 4 is an exemplary method according to certain embodiments; and

FIG. 5 is another exemplary method according to certain embodiments.

### DESCRIPTION OF EXEMPLARY EMBODIMENTS

This disclosure relates to a logistics automation platform that includes tools for generating dynamic models that are utilized for automating logistics planning and management operations at various sites. The dynamic models can be utilized to automate logistics planning and management operations for hazardous biological conditions (e.g., hazardous conditions related to legionella) and chemical conditions at various sites. The dynamic models additionally, or alternatively, can be utilized to automate logistics planning and management operations for IFM operations and other workflows at various sites.

The dynamic models generated by the platform are customizable at granular levels to account for the specific logistical challenges at each of the sites. The dynamic models may be integrated into software applications that are accessible by various stakeholders (e.g., property managers, vendors, and site personnel) tasked with managing or implementing operations at the sites. The stakeholders can utilize the software applications to provide inputs and feedback directed to carrying out operations and for managing the tasks. The platform also can be configured to receive inputs comprising real-time data from equipment and sensors that monitor conditions at the sites. The software applications can utilize the dynamic models to automate process flows at the sites, and to automatically select and present interfaces to the stakeholders based on the received inputs and feedback received from the stakeholders and/or monitoring equipment.

A dynamic model for capturing the logistical operations of a site is comprised of a plurality of nodes that are linked to one another with connectors to control how the workflow will proceed based on received inputs. The nodes are typically configured to represent activities associated with a workflow and can be customized according to various criteria discussed herein, and the connectors indicate how the workflow transitions among the nodes and may indicate time frames for completing activities associated with the nodes. The platform includes a modeling tool that enables users to quickly and easily generate customized models for the logistics planning and management operations at each of the sites. The modeling tool presents one or more interfaces that enable a user to specify various criteria for the nodes and their associated connectors at very granular levels. In certain embodiments, the interfaces enable the user to define the type of node that is being included in the diagram; to specify and associate a plurality of sub-tasks with the node; to designate individuals (e.g., third-party vendors or in-house personnel) who are responsible for executing or overseeing tasks associated with the node; to link the nodes to other diagrams (e.g., in order to initiate execution of parallel workflow threads); to link the nodes to inputs provided by input forms and/or other inputs received from site equipment (e.g., real-time inputs generated by sensors and/or monitoring equipment); and to specify conclusion parameters that are utilized to control how the workflow will proceed to other nodes included in the diagram based on the received inputs and/or detected conditions at the site.

In certain embodiments, the modeling tool is configured to generate a node-based diagram for a site that captures or represents the logistical workflow at the site. The modeling tool is configured to present graphical user interfaces (GUIs) to create and update the node-based diagrams. The interfaces presented include functions for creating new diagrams, inserting a variety of different nodes into the diagrams, dynamically linking the nodes to customized interfaces incorporated into software applications presented to stakeholders, dynamically linking the nodes to real-time data captured by equipment at the sites (e.g., monitoring equipment and sensors), and dynamically linking the nodes to one or more additional diagrams to initiate concurrent workflows that execute in parallel to one another.

The interfaces displayed by the modeling tool provide an interactive, node-based diagram that visually represents the dynamic models using a plurality of nodes and their associated connections. Each node of the diagram is associated with criteria that can be customized by an individual who is utilizing the modeling tool to create a diagram. The criteria associated with the node can link the node to inputs received from individuals associated with implementing the workflow and/or inputs received from sensory equipment located at the sites (e.g., sensors for monitoring conditions at the sites). The criteria associated with the node can also define conclusion parameters that control how the process flow will progress to other nodes included in the dynamic model that was generated. The conclusion parameters may be utilized to control the procession of the process flow to other nodes based on the inputs received from the individuals and/or the inputs received from sensory equipment.

The dynamic models generated by the logistics automation platform utilize a ruleset to detect certain triggering events that will automatically initiate one or more actions to be taken by the platform. The ruleset is defined, at least in part, by the criteria specified for the nodes. In certain embodiments, a user can add rules to the ruleset when the user is defining the nodes that are being added to the diagram being created with the modeling tool. For example, rules can be added to automatically generate alerts or notifications (e.g., push alerts, alerts displayed on interfaces, and/or inbox messages associated with user accounts) in response to detecting triggering events that indicate actions should be taken at the sites. This can include the sending of alerts and notifications associated with corrective measures at the sites in response to detecting certain conditions at the sites (e.g., in response to detecting unacceptable biological or chemical conditions at the sites). This may involve initiating automatic procedures for scheduling vendors to perform certain tasks and/or activating remediation equipment at those sites.

The dynamic models created and utilized by the platform can be easily updated or modified as the logistical needs of a site change over time. The underlying data associated with the diagrams are stored in a database provided by the platform. A user seeking to update a previously created dynamic model can load a stored model that will be presented on a GUI to the user via the modeling tool feature. The user can then provide inputs via the GUI to easily update the dynamic model. For example, the user can add, edit, or delete nodes; adjust the workflow transitions between the nodes; and/or adjust criteria associated with nodes (e.g., edit node types and/or conclusion parameters). Once a model has been updated, the updated model is automatically integrated into the software solutions utilized by the stakeholders to manage workflows at the site. In certain embodiments, the dynamic model is accessed by the stakeholders over a network at a centralized location and the updating is performed automatically given the centralized configuration of the system.

The logistics automation platform can generally be configured to provide assistance with automating the planning, management, and execution of logistics operations in any type of business, organization, or industry. The logistics automation platform is particularly useful for businesses, organizations, or industries involving complex logistics operations that require customized solutions at very granular levels. In certain embodiments, the logistics automation platform is configured to provide assistance with logistics operations with one or more of the following: property management services and operations; transportation services and operations; military services and operations; manufacturing services and operations; and inventory management services and operations. The logistics automation platform can also be utilized in other types of business-related or government-related services and operations.

In certain embodiments, the logistics automation platform is configured to provide assistance with automating logistical operations associated with property management operations. For example, in certain embodiments, the logistics automation platform is integrated with, or otherwise utilized by, the platform described in U.S. patent application Ser. No. 15/715,698, the content of which is herein incorporated by reference in its entirety.

In these embodiments, the logistics automation platform can be configured to ensure compliance with regulatory schemes directed to managing biological and/or chemical conditions at different properties or sites. For example, the logistics automation platform can be configured to create dynamic models that control logistics operations associated with treating water stored in water towers or cooling towers for legionella and other biological agents. The dynamic models can utilize data received by the platform from various stakeholders and/or monitoring equipment to detect triggering events and to trigger actions to be undertaken. For example, the received data can trigger actions such as taking water samples for laboratory testing, cleaning and treating water with biocides, cleaning water tower structures, draining and filling the tower structures, and performing maintenance on the tower structures and associated water systems. The dynamic models automate the coordination of actions among various parties (e.g., property managers, third-party service providers or vendors, and governmental compliance personnel) to ensure safe conditions at the sites and to take any necessary corrective or preventive measures.

In certain embodiments, the dynamic models generated by the logistics automation platform can also be configured to provide assistance with property management operations that involve integrated facilities management (IFM) tasks. The dynamic models can be configured to control process flows of operations that include tasks associated with interior property services (e.g., building maintenance, plumbing services, electrical services, HVAC services, computer services, and/or cleaning services), exterior property services (e.g., construction projects, snow removal, and landscaping services), safety conditions (e.g., related to safety measures associated with protection against fires, earthquakes, tornadoes, or inclement weather), property-related governmental regulations (e.g., housing regulations, zoning regulations, and/or regulations pertaining to landlords), and/or and other types of tasks. Once again, the dynamic models can utilize data received by the platform from various stakeholders and/or monitoring equipment to detect triggering events (e.g., breakdown of equipment) and to trigger any necessary corrective actions or preventive measures (e.g., scheduling vendors or individuals to attend to tasks).

The platform and related features described in this disclosure provide numerous advantages over prior art techniques for managing logistics operations. With prior art techniques, the logistics of managing operations at a plurality of properties has largely been handled manually because the complex logistical challenges for each site can vary greatly. In contrast, the logistics automation platform described herein provides a solution that permits property managers to generate customized, dynamic models that are tailored to logistical challenges at each of the sites and which allow for automation of logistical operations at the sites. The platform reduces the time and expense associated with handling logistics at each of the sites, and provides a single, centralized platform that can be utilized to handle operations at a plurality of sites. By integrating the dynamic models into software solutions that are accessible to the various stakeholders (e.g., property managers, in-house employees, third-party service providers, and testing laboratories), all relevant stakeholders are immediately able to take necessary actions and/or corrective measures. Further, by integrating the dynamic models into software solutions that communicate with equipment (e.g., monitoring equipment and remediation equipment) at the sites, unfavorable conditions can be detected in real-time, and devices at the sites can be remotely activated to cure, mitigate, or prevent occurrences of the unfavorable conditions. These advantages are particularly important in scenarios where failure to take quick and immediate actions can result in harm or death to individuals.

The inventive principles set forth in the disclosure provide the above-described advantages by applying technical improvements that are rooted in computer and automation technologies to overcome existing problems associated with ensuring compliance with regulations or other obligations, specifically problems dealing with the monitoring of environmental and facilities management conditions and automating logistics operations at sites. These technological improvements provide tools for generating dynamic models and integrating the models into software solutions in a user-friendly manner that does not require individuals to possess technical knowledge, and which account for the dynamic nature of logistics operations. The models generated using the platform can be easily linked other models to initiate separate threads for workflows or sub-routines to be carried out in parallel. Further, the dynamic models permit automated control of logistics operations at various sites based on inputs received from integrated equipment (e.g., sensors, devices, and/or equipment at the sites) and supplied by the stakeholders. These inputs allow for real-time monitoring of conditions at the sites and permit automated remedial actions to be immediately undertaken (e.g., by activating remediation equipment at the sites and/or notifying applicable stakeholders to take actions). Thus, the dynamic models created and utilized by the centralized platform enable simultaneous monitoring of environmental conditions, facilities management conditions, and other conditions at a plurality of sites. This technology-based solution marks a technical improvement over existing tasks for managing logistics operations and ensuring compliance with environmental regulations and facilities management obligations by improving the manner in which unfavorable conditions are detected and managed at the sites.

The embodiments described in this disclosure can be combined in various ways. Any aspect or feature that is described for one embodiment can be incorporated into any other embodiment mentioned in this disclosure. Moreover, any of the embodiments described herein may be hardware-based, software-based and, preferably, comprise a mixture of both hardware and software elements. Thus, while the description herein may describe certain embodiments, features, or components as being implemented in software or hardware, it should be recognized that any embodiment, feature, or component that is described in this disclosure may be implemented in hardware and/or software. In certain embodiments, particular aspects are implemented in software which includes, but is not limited to, firmware, resident software, microcode, etc.

Embodiments may include a computer program product accessible from a computer-usable or computer-readable medium providing program code for use by, or in connection with, a computer or any instruction execution system. A computer-usable or computer-readable medium may include any apparatus that stores, communicates, propagates, or transports the program for use by, or in connection with, the instruction execution system, apparatus, or device. The medium can be a magnetic, optical, electronic, electromagnetic, infrared, or semiconductor system (or apparatus or device), or a propagation medium. The medium may include a computer-readable storage medium, such as a semiconductor or solid state memory, magnetic tape, a removable computer diskette, a random access memory (RAM), a read-only memory (ROM), a rigid magnetic disk, an optical disk, etc.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output (I/O) devices (including, but not limited to, keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The discussion that follows below is directed to exemplary embodiments in which the platform is configured to assist property managers with handling logistics operations associated with managing environmental conditions and IFM operations at various sites. However, it should be recognized that the inventive principles discussed below, and throughout this disclosure, can be adapted for use with other types of industries, organizations, businesses, or services (e.g., those associated with transportation, military, manufacturing, inventory control, and/or other services).

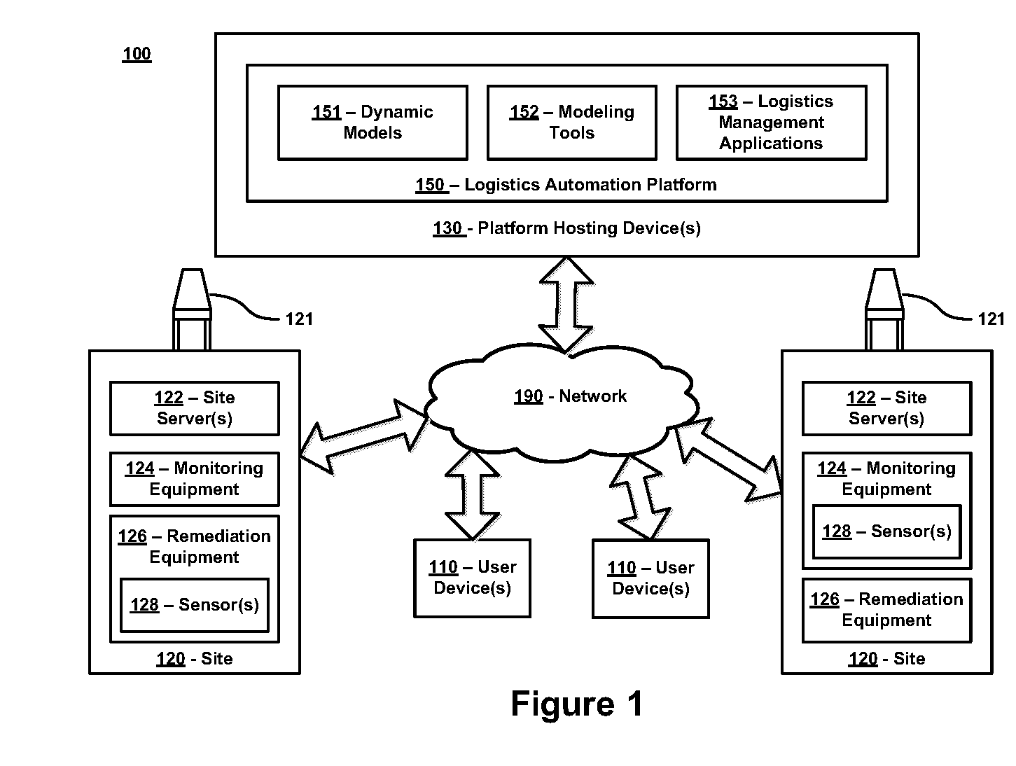

FIG. 1 is a block diagram of a system 100 according to certain embodiments. A platform hosting device 130 includes a logistics automation platform 150 that provides a comprehensive set of modeling tools 152 for designing customized dynamic models 151 that can be integrated into logistics management applications 153 to automate workflow control and management operations in a manner that accounts for dynamically changing conditions at a plurality of sites 120. In certain embodiments, the dynamic models 151 are able to be customized for each site to enable automated control of any and all operations associated with preventing, mitigating, and/or remediating occurrences of unfavorable conditions (e.g., hazardous biological/chemical conditions or facilities management conditions) at the sites 120. In this exemplary system, one or more of the sites 120 include cooling towers 121 or water towers 121. The platform hosting device 130 is in communication with the sites 120 over a network 190. The platform hosting device 130 is also in communication with one or more user devices 110, which are operated by various stakeholders such as site/facility/building managers, service providers/vendors, property owners, platform administrators, and other individuals.

In certain embodiments, the platform 150 represents a network-based, web-based, and/or cloud-based platform that is accessed over the network 190 by the user devices 110 operated by the stakeholders. The network 190 can be any type of network, such as one that includes the Internet, a local area network, a wide area network, an intranet, a cellular network, and/or other network. The platform 150 is hosted on one or more servers, or other devices, which are configured to communicate with the user devices 110 and the sites 120 (e.g., to communicate with servers 122, monitoring equipment 124, remediation equipment 126, sensors 128, and/or other devices located at the sites 120). The user devices 110, site servers 122, and platform hosting devices 130 may represent desktop computers, laptop computers, mobile devices (e.g., cell phones, smart phones, or personal digital assistants), tablet devices, wearable devices (e.g., smart watches, smart glasses, etc.) or other types of computing devices. The user devices 110, sites 120, servers 122, monitoring equipment 124, remediation equipment 126, sensors 128, and platform hosting devices 130 can be configured to communicate via wired or wireless links, or a combination of the two. These components can communicate directly with one another and/or via the network 190. Each may be equipped with one or more computer storage devices (e.g., RAM, ROM, PROM, SRAM, etc.) and one or more processing devices (e.g., central processing units) that are capable of executing computer program instructions. The computer storage devices are preferably physical, non-transitory mediums.

In certain embodiments, the computer storage devices of the platform hosting device 130 are configured to store data, applications, scripts, databases, and/or other information for implementing any and all functions described herein, including functions for generating dynamic models 151 (e.g., using the modeling tools 152), integrating the dynamic models 151 into logistics management applications 153, utilizing the dynamic models 151 and logistics management applications 153 to track and manage logistics operations at the sites 120, and other related features described in this disclosure. The user devices 110 operated by the property managers, service providers, and other users can include software applications that communicate with the platform 150 to access the dynamic models 151, modeling tools 152, logistics management applications 153, data, applications, scripts, databases, interfaces, and/or other information on the platform hosting device 130. The software applications can also enable the user devices 110 to access the sites 120 (including all of its components) via the platform 150 and/or directly in order to remotely access and control the monitoring equipment 124 and remediation equipment 126. In certain embodiments, the platform 150 is alternatively, or additionally, implemented as a local application that is installed on the user devices 110 operated by the users or site servers 122.

Each instance in which a property manager, individual, or organization desires to automate operations at a site 120, an authorized person, member, or user can access the modeling tools 152 on the logistics automation platform 150 to generate a new dynamic model 151 for monitoring and controlling the workflow at the site 120. For example, an option can be selected to create a new model 151 for automating logistics associated with monitoring and controlling the workflows at the site 120 for environmental conditions and/or IFM activities. Once the model 151 has been generated, it can be integrated into a logistics management application 153 that is accessible and utilized by different stakeholders utilizing the user devices 110. Inputs received from stakeholders utilizing the user devices 110 and/or equipment (e.g., monitoring equipment 124 and/or remediation equipment 126) is received over the network 190 by the platform, and the logistics management applications 153 utilize the integrated dynamic models 151 to make appropriate decisions regarding the workflows at the sites 120 and to take appropriate actions. The inputs are utilized by the models 151 to dynamically monitor, control, and manage operations at the sites 120.

The modeling tools 152 may be utilized by property managers, platform administrators (e.g., associated with a third-party service that provides the logistics automation platform 150 as a service to property managers and other individuals), or other users. In certain embodiments, the modeling tools 152 present the users with one or more graphical user interfaces (GUIs) that permit the users to create a node diagram that represents or models the workflow for a site 120. The users may utilize the one or more GUIs to insert nodes into the diagram and link the nodes to one another. The one or more GUIs may further permit the users to specify node criteria for each node. As discussed in further detail below, the node criteria can specify, inter alia: a node type that identifies the type of node being added (e.g., whether the node being added is being utilized to represent a specific workflow job or task, involves testing tasks to be conducted, and/or links to another model or diagram that initiates execution of a concurrent thread); inputs that are required for the node (e.g., inputs from service providers or equipment); conclusion parameters that specify where the process flow will transition based on the received inputs (e.g., which identify a node where the process flow will transition based on the inputs); event triggers that will cause certain actions to be undertaken (e.g., sending alerts/notifications or initiating corrective measures or preventative measures to be taken); vendors, service providers, in-house personnel, or other individuals who are to perform or oversee tasks associated with the node; and other criteria.

In certain embodiments, multiple dynamic models 151 may be utilized to automate logistics operations at a single site 120. For example, a user may utilize the modeling tools 152 to generate a first dynamic model 151 for controlling the workflow associated with managing environmental conditions pertaining to legionella testing; a second dynamic model 151 for controlling conditions pertaining to chemical testing (e.g., conditions associated with controlling asbestos, lead, or radon levels); a third dynamic model 151 for controlling conditions pertaining to other types of biological testing (e.g., conditions associated with controlling mold, insects, bacteria, or rodents); and a fourth dynamic model 151 for controlling IFM operations (e.g., for controlling interior or exterior IFM operations). Along similar lines, each of the dynamic models 151 mentioned above can be divided into a plurality of models 151 which are linked to one another, each of which is associated with controlling a subset of tasks associated with the model 151. For example, the dynamic model 151 for controlling the workflow of environmental conditions pertaining to legionella testing can be divided into several sub-models that control workflows for various tasks (e.g., tasks associated with treating and cleaning water, cleaning water tower structures, applying pesticides or disinfectants, supplying laboratory results, etc.) and each of the sub-models can be linked together.

In certain embodiments, a hierarchy of separate models 151 can be generated using the modeling tools 152 and the models can be linked together in a parent/child arrangement to control and monitor logistical operations. For example, a master model can be created for controlling and managing legionella conditions (or other hazardous conditions) at a site 120. The master model can be linked to one or more sub-models for controlling and managing a subset of tasks associated with managing the legionella conditions. For example, as mentioned above, the sub-models may be used to control and manage workflows for sub-tasks associated with treating and cleaning water, testing water conditions, cleaning water tower structures, applying pesticides or disinfectants, supplying laboratory results, etc. The master model can include nodes that initiate execution of the workflows associated with the sub-models in response to detecting certain conditions. For example, in response to detecting unsatisfactory legionella conditions at a node in the master model, the workflow may transition to a node that initiates execution of a sub-model that controls the workflow for mitigating or correcting the hazardous legionella conditions at the site 120. The hierarchy of linked models 151 can include any number of levels and can be customized according to the needs of the site 120. The modeling tools 152 can be utilized to specify whether or not sub-models are to be executed in parallel with the workflows of parent models, or whether the workflow of the parent models should be halted until execution of the sub-model has completed.

The logistics management applications 153 utilize the dynamic models 151 to control logistics operations at the sites 120. The user devices 110 permit stakeholders to access the logistics management applications 153 over the network 190. While the logistics management applications 153 are shown as being stored on the platform hosting device 130, the logistics management applications 153 can alternatively, or additionally, be stored in whole or part on the user devices 110. For example, the user devices 110 may include a front-end application that communicates with the logistics management applications 153 on the platform hosting device 130, and/or the entirety of the logistics management applications 153 may be stored on the user devices 110. The logistics management applications 153 provide interfaces to the stakeholders, which enable the stakeholders to provide inputs and feedback for executing or managing tasks defined by the dynamic models 151, to view statuses of workflows, to communicate with other stakeholders, to communicate with and control equipment at the sites 120 (e.g., monitoring equipment 124 and/or remediation equipment 126), to allocate tasks associated with the workflows to different stakeholders (e.g., in-house personnel and/or vendors), to receive alerts and notifications associated with executing and managing workflows, and to perform any other related functions discussed in this disclosure.

The logistics automation platform 150 can be configured to provide different types of permissions and interfaces to different stakeholders. For example, the logistics management applications 153 utilized by property managers and platform administrators may allow these stakeholders to perform a broad range of functions, e.g., such as generating and updating dynamic models 151, accessing the modeling tools 152, updating models 151 and workflows, controlling equipment at the sites 120, assigning vendors, laboratories or service providers to perform various tasks, and communicating with any associated stakeholders. The logistics management applications 153 utilized by vendors or service providers may allow these stakeholders to perform a more limited subset of tasks, e.g., such as providing inputs in connection with tasks assigned to specific vendors or service providers, uploading laboratory results, and accessing equipment that permits monitoring and/or remediation of site conditions that are associated with tasks assigned to the vendors or service providers. The property managers and platform administrators can specify which functions are available to the vendors or service providers. The logistics management applications 153 can be configured to provide appropriate interfaces to the stakeholders based on the permissions and functions available to the stakeholders.

In certain embodiments, the property or facility managers access the platform 150 to receive alerts for determining whether tasks need to be scheduled (e.g., for complying with environmental regulations or facilities management obligations), checking statuses of upcoming or scheduled tasks, curing unfavorable conditions, and for other reasons. In certain embodiments, the scheduling of tasks is based on obligations imposed by regulatory compliance measures (e.g., which require property managers to periodically check certain environmental conditions at sites) and/or facilities management obligations. The dynamic models 151 and/or logistics management applications 153 identify any relevant deadlines, tasks, or actions that should be taken in connection with fulfilling the obligations. The dynamic models 151 include criteria that specifies when stakeholders are to be notified or scheduled to perform tasks (e.g., tower cleaning, water treatment, and laboratory testing). The scheduling of tasks can also be initiated by the detection of unfavorable or potentially unfavorable conditions at the sites 120. The detection of such conditions can be performed by in-person inspections performed by service providers and/or automatically by monitoring equipment located at the sites (e.g., which include sensor devices configured to detect biological or chemical substances in the water or air supply at the sites).

The logistics automation platform 150 can automatically transmit notifications or alerts to user devices 110 (e.g., via the logistics management applications 153) operated by property managers, vendors, and/or other users at any appropriate time to notify the users of any events requiring their attention. In certain embodiments, the logistics management applications 153 are configured to automatically detect when environmental tasks should be performed or scheduled, when property managers are delinquent on their obligations to perform environmental tasks, and/or when unfavorable conditions are present at sites. The platform 150 transmits notifications to the users in the event that any such events are detected.

Each dynamic model 151 stores or includes a set of rules and event triggers that can immediately activate the sending of notifications, initiate a series of corrective measures, and/or perform other related functions. For example, in the event that the platform 150 receives an indication that unsatisfactory laboratory results have been obtained in connection with legionella testing (or other biological/chemical testing) at a site 120, the platform 150 can retrieve the dynamic model 151 associated with the site 120 to initiate a series of corrective measures (e.g., setting deadlines to correct measures, scheduling appropriate vendors for treating water, and scheduling a laboratory to analyze the treated water). Likewise, in response to detecting a broken HVAC system, the platform 150 can retrieve the dynamic model 151 associated with controlling IFM operations at the site 120 and initiate a series of corrective measures, such as notifying tenants/occupants of conditions, scheduling HVAC repair services, and reserving alternative space in the building for the tenants/occupants while repairs are ongoing. Any corrective measures taken by the platform 150 can be performed automatically by the platform 150 and/or with the assistance of an individual (e.g., property manager). The platform 150 can utilize the rules and triggers to perform similar actions in other scenarios involving other types of events.

The logistics management applications 153 can utilize the dynamic models 151 to prompt property managers to select or assign one or more vendors or service providers for completing the tasks. Generally speaking, the service providers listed on and made available via the platform can perform any task desired by the property managers. For example, in the context of ensuring compliance with environmental regulations pertaining to water towers or cooling towers 121, the vendors can be called on to perform tasks related to treating and cleaning water, cleaning water tower structures, applying pesticides or disinfectants, supplying laboratory results (e.g., which provide an analysis of biological or chemical parameters present in the water), draining and filling the tower structures, and performing maintenance on the tower structures or water systems. The service providers scheduled through the platform 150 can perform tasks related to ensuring compliance with other types of environmental regulations (e.g., relating to asbestos, mold, etc.). The service providers scheduled through the platform 150 can also perform tasks related to facility management operations, such as tasks associated with building maintenance, cleaning services, construction services, computing services, snow removal services, security services, landscaping services, etc.

The platform 150 can be configured for use with facilities management software applications and systems that can provide assistance with maintenance and other site services; computer-aided facility management (CAFM) software and systems that can provide various forms of information technology pertaining to the sites; building automation systems (BAS) software that automates various aspects of a building (e.g., a building's heating, ventilation and air conditioning, lighting, and other systems); and/or any other type of system or software application that provides assistance with managing a site 120. The platform 150 can be directly integrated and packaged with such systems or software applications, or can communicate with such systems and software applications (e.g., via an application programming interface or API).

As mentioned above, in certain embodiments, the platform 150 is configured to communicate with monitoring equipment 124 and remediation equipment 126 located at the sites 120. The dynamic models 151 can specify how data generated by such equipment is utilized to implement workflows at the sites 120 and/or when such equipment is to be activated or utilized to implement the workflows. For example, when creating or updating a dynamic model 151, a user may specify that a node included in the diagram for the model is to utilize data generated by monitoring equipment 124 to determine how the workflow is to proceed. Likewise, the user may also specify that a node is to activate remediation equipment 126 in response to detecting unfavorable conditions (e.g., hazardous biological or chemical conditions) at a site 120.

Generally speaking, the monitoring equipment 124 is utilized to determine whether unfavorable or potentially unfavorable conditions exist at the sites 120 and/or to determine whether service providers should be scheduled to perform tasks at the sites 120. The monitoring equipment 124 can be configured to detect the presence of hazardous or unfavorable conditions at the sites utilizing sensors 128, analysis hardware or software, and/or associated devices and circuitry. For example, the monitoring equipment 124 at a site 120 may include devices that include sensors 128 and/or analysis software for detecting the presence or potential presence of biological or chemical hazards, acidity conditions, weather conditions, and/or equipment functionality (e.g., HVAC, computing, electrical, or plumbing equipment functionality). Analog inputs received via the sensors can be converted to digital signals and evaluated by the analysis software to detect the presence of such hazards or unfavorable conditions. In response to detecting an unfavorable or potentially unfavorable condition at a site 120, the monitoring equipment 124 can transmit a signal (using wired or wireless communication techniques) over the network 190 to the platform 150 and site server 122. The alert signal can then be relayed to one or more user devices 110 to notify the associated property manager (or other individuals) of the detected condition. The alert signal can also be utilized by the dynamic models 151 to automatically initiate certain corrective actions. In this manner, the platform 150 provides real-time monitoring of environmental and facility conditions at the sites 120 and allows remediation actions to be taken to cure the conditions. In certain embodiments, in response to the monitoring equipment 124 detecting an unfavorable condition at a site, the ruleset associated with the dynamic model 151 for the site 120 triggers the platform 150 to automatically present the property manager with a series of corrective measures, and the system identifies and stores appropriate deadlines, task information, and related data for curing the condition.

The dynamic models 151 may include information which causes the platform 150 to execute a variety of actions for curing, mitigating, and/or remediating unfavorable conditions at the sites 120. In certain embodiments, dynamic models 151 can cause the platform 150 to control and utilize the remediation equipment 126 to cure or prevent unfavorable conditions at the sites 120. Generally speaking, the remediation equipment 126 can represent any device capable of providing assistance with preventing or correcting unfavorable conditions at a site 120. Exemplary remediation equipment 126 includes equipment for treating water (e.g., by treating the water with biocides, with filters, or in other ways), air, soil, or other environmental aspects at the sites 120. Other types of remediation equipment 126 can include facilities management equipment, such as automated snow removal devices, automated floor cleaning devices (e.g., autonomous robotic cleaners that scrub, vacuum, sweep or otherwise clean floors), air filtering devices, and other types of automated facilities management devices.

In certain embodiments, the remediation equipment 126 includes one or more sensors 128 for monitoring conditions. Any type of sensor 128 can be used. The remediation equipment 126 (and/or sensors 128) is in communication (e.g., via wired or wireless communication) with the platform 150, site servers 122, and/or monitoring equipment 124. The dynamic models 151 can specify that the remediation equipment 126 is to be activated automatically (e.g., in response to the monitoring equipment detecting an unfavorable condition) or in response to a platform user selecting activation options that are made available via the platform 150.

The logistics management applications 153 provide the user with controls (e.g., which are displayed on an interface of the user device 110) for activating/de-activating the remediation equipment 126 and for controlling the remediation equipment 126 in various ways. The logistics management applications 153 provide a customized set of controls for each device included with the remediation equipment 126, which take advantage of the hardware and functionality of devices. For example, if water treatment equipment is made available at a site 120, the remediation component 126 can provide a user with controls for selecting biocides and disinfectants to be administered, specifying levels of biocides or disinfectants to be applied, specifying filtration parameters, specifying maximum acceptable contaminant levels, and any other parameters associated with treating water. Likewise, if an autonomous floor cleaning device is provided at a site 120, the controls can allow locations that require cleaning to be specified, along with the type of cleaning (e.g., scrubbing cleanse, vacuum cleanse, soap cleanse, etc.) to be performed at the locations. Appropriate controls can be customized for each of the devices included in the remediation equipment 126.

The logistics automation platform 150 can be configured to generate various reports in both digital and print formats. The reports can be utilized to satisfy compliance and regulatory rules, to enable record-keeping at the sites, and/or for other reasons. The reports can provide summaries of the tasks that were performed at each of the sites 120 (e.g., indicating when the tasks were performed, who performed them, test results generated in carrying out the tasks, etc.). The reports can be transmitted over the network 190 to user devices 110 and/or other third-parties (e.g., governmental compliance entities).

In certain embodiments, such as those in which the logistics automation platform 150 is utilized to manage legionella conditions at the sites, the logistics automation platform 150 can be configured to generate a site report. The site report can represent a detailed report that is generated to ensure compliance with regulatory measures associated with maintaining cooling or water towers 121 and/or managing legionella conditions associated with cooling or water towers 121. For example, the site report can include various sections that include a year-to-date summary of site conditions, corrective actions that were undertaken to mitigate or prevent legionella in cooling or water towers 121, water testing results, and monitoring tasks. Because this detailed site report can be complicated and confusing to create, the documents (physical or digital) that are to be included in the report can be coded with specific color markings, or otherwise organized, to ensure that property managers place the documents in the proper sections of the report. The nodes of the dynamic models 151 can be used to specify the markings that are applied to each of the documents.

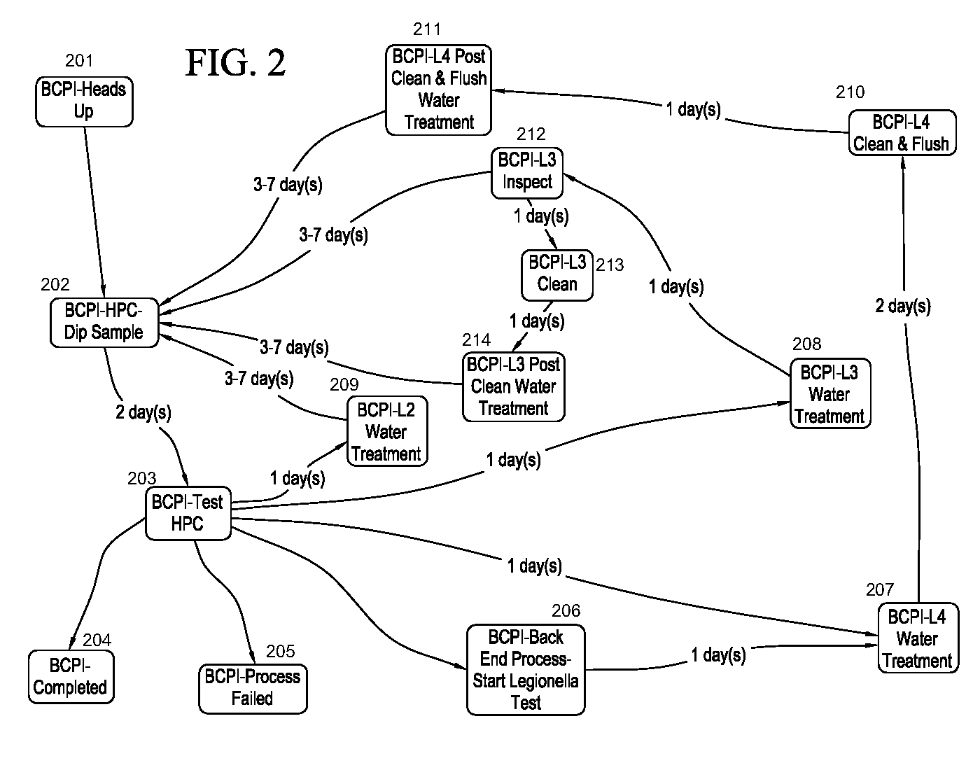

FIG. 2 is an exemplary node diagram utilized to represent a dynamic model generated by the logistics automation platform 150 according to certain embodiments. This exemplary node diagram provides a dynamic model 151 for controlling a workflow associated with handling legionella detection and testing at one or more sites (e.g., such as sites 120 in FIG. 1). The node diagram can be created by a user (e.g., platform administrator or property manager) using the modeling tool 152. Using the modeling tool 152, nodes are inserted into the diagram along with connectors that indicate how the workflow is to transition among the nodes. Each time a node is added, various criteria is associated with the node, e.g., such as inputs that are to be evaluated by the node and conclusion parameters that indicate how the workflow will proceed to other nodes. The criteria can also specify individuals (e.g., in-house employees or third-party vendors) who are responsible for performing, managing, or overseeing the tasks, and it can identify forms that allow those individuals to provide feedback associated with the tasks. The connectors between the nodes indicate time frames for performing tasks.

The process illustrated in FIG. 2 begins in the top left corner at node 201 and proceeds to node 202 that represents a task for taking a water sample. The flow then proceeds to node 203 that represents a test is to be performed on the water sample. The transition between nodes 202 and 203 indicates that the test is to be performed within two days of taking the water sample. The test results of the water test will be received as inputs by node 203. The conclusion parameters specified for the node 203 will determine how the workflow will transition to one of six nodes (i.e., nodes 204-209) based on the test results received by the node 203.

If the tests results are favorable (e.g., indicating no presence of legionella or other hazardous conditions), then the workflow will proceed to node 204 and the process will end. If the tests results are inconclusive or an error occurs, the workflow will proceed to node 205, which indicates the process has failed. This may automatically restart the process. Otherwise, if the test results indicate that the water should be treated, the process can proceed to node 207, 208, or 209 based on the level of treatment required. For example, if minimal treatment is required, the workflow may proceed to node 209, which involves the task of water treatment and then back to node 202, which restarts the sampling and testing process. If greater levels of treatment are required, the workflow may proceed to paths associated with node 207 or node 208. If the workflow proceeds down either of these paths, the workflow may proceed to nodes indicating that a variety of tasks associated with corrective measures may be taken. The corrective measures can include tasks for treating, cleaning, and/or flushing the water (nodes 207, 208, 210, 211, 213, and 214) in the water towers, and scheduling inspections (node 212) with personnel responsible for ensuring compliance with applicable regulations. The paths or transitions connecting node 203 to nodes 207 and 208 ultimately lead back to node 202 where the sampling process is restarted.

If the testing performed at node 203 detects a likelihood of legionella, then the workflow proceeds to node 206. Transitioning of the workflow to node 206 will automatically initiate execution of a sub-model or child model that includes another node diagram that controls the specific workflow for testing and treating water for legionella. Depending upon the criteria specified for node 206, the execution of the sub-model or child model can be performed concurrently with the execution of the model shown in FIG. 2, or the workflow in FIG. 2 can be halted until the sub-model initiated by node 206 has completed.

As mentioned above, the dynamic models 151 (e.g., such as the one represented by the diagram in FIG. 2) can be integrated into, and utilized by, the logistics management applications 153 to automate workflows at the sites 120. The logistics management applications 153 can present appropriate interfaces to various stakeholders to permit the operations associated with the nodes to be carried out. For example, the interfaces may permit inputs to be provided that specify laboratory results pertaining to water tests (e.g., at node 202 and 206), confirm performance of water treatment operations (e.g., at nodes 207, 208, and 209), confirm performance of cleaning and/or flushing operations (e.g., at nodes 210, 211, 213, and 214), and/or confirm inspections were conducted (e.g., at node 212).

The criteria specified for the nodes may identify individuals (e.g., vendors, property managers, or employees) that are to perform the various tasks (e.g., treating, cleaning, and/or flushing tasks). The criteria can also specify if and when alerts are to be sent to individuals associated with the workflow. The criteria may further specify inputs required or expected to be received at each node, and conclusion parameters for transitioning the workflow downstream to other nodes based on the inputs. As discussed in further detail below, other criteria may be associated with the nodes.

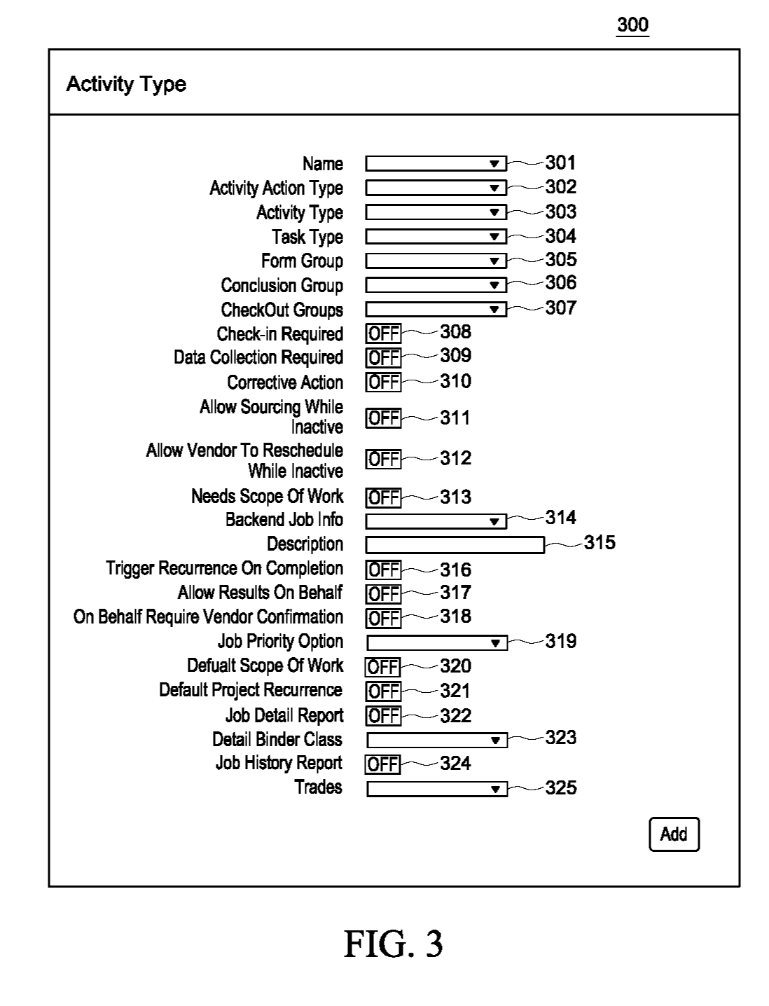

FIG. 3 is an exemplary interface 300 for defining node criteria and adding nodes to be inserted into a node diagram for a dynamic model according to certain embodiments. This interface 300 may be presented by the modeling tools 152 to a user that is creating or updating a dynamic model 151. When the user is finished specifying the criteria for the node, the user may select the “Add” button in the lower right corner of the interface and the node will be added to the dynamic model 151, and/or an existing node included in the dynamic model 151 may be updated. In certain embodiments, this may involve updating a visual representation of a node diagram (e.g., as shown in FIG. 2) to include the newly added node.

The exemplary interface 300 includes a plurality of different input fields (e.g., which can include drop down menus, buttons, text fields, etc.) for specifying various criteria for the node being added. Each of these is discussed below.

A “name” field 301 permits a user to specify a name for the node being added. In certain embodiments, the interface may also include a second field that enables a user to specify a “short name” for the node being added. When either the name or the short name is updated on the backend of the system, the changes can be viewed instantly by vendors and other users who are utilizing the logistics management applications 153.

An “activity action type” field 302 permits a user to specify the type of node that is being added. Exemplary node types may include:

(1) Job=This node type indicates that a certain type of task is to be performed when workflow proceeds to the node. Exemplary tasks may include taking water samples, cleaning and treating water with biocides, cleaning water tower structures, draining and filling the tower structures, and performing maintenance on the tower structures. Nodes 202, 207, 208, 209, 210, 211, 213, and 214 are examples of job nodes.
(2) Test=This node type indicates that a test is to be performed when workflow proceeds to the node. For example, a test node may indicate that a laboratory is to conduct tests for detecting legionella or other biological/chemical contaminants. Node 203 in FIG. 2 is an example of a test node.
(3) Stop & Restart=This node type is a termination block, which causes the workflow to stop and start over from the beginning. Node 205 in FIG. 2 may represent a Stop & Restart node, which causes the workflow to stop and restart because of an error or inclusive test results.
(4) Activity Model Job=This node type terminates the process or workflow associated with the model, including all associated jobs that are currently ongoing, and initiates a new process or workflow by referencing a new specified activity model. This node type can be utilized to divert the current project or workflow to a completely new path (e.g., in the event that it is determined that the current workflow is unable to provide the desired outcome).
(5) Backend Project=This node type links to another model (e.g., a sub-model or child model). It activates a new process to be executed in connection with the workflow. The workflow associated with the other model may be executed concurrently with the model to which the node is being added. Node 206 in FIG. 2 is an example of a backend project node that activates a new workflow defined by a dynamic model 151 for testing or handling the detection of legionella.
(6) No operation=This node type does not perform any operation or execute any job. For example, this type of node can be utilized to represent a final end node, which terminates or marks completion of the workflow. In certain circumstances, this can be utilized if a decision node directs the workflow to a decision branch that indicates the process should end.

An “activity type” field 303 indicates the type of function that is to be performed. For example, if the activity action type field 302 is defined to be a job node, the activity type field 303 may indicate which type of job is to be performed. For example, as mentioned above, the activity type field 303 may specify that that the job is for taking water samples, cleaning and treating water, cleaning water tower structures, draining and filling the tower structures, and performing maintenance on the tower structures. Similarly, if the activity action type field 302 is defined to be a test node, the activity type field 303 may indicate the type of test that is to be conducted.

A “task type” field 304 is used to specify one or more sub-tasks that are to be completed in connection with performing the function identified by activity type field 303. For example, if the selected activity type is for draining and filling water towers, the task type field 304 may specify that a vendor is to be scheduled to perform the draining and filling activities, and that the vendor is to provide feedback to the platform 150 confirming that the sub-tasks have been performed. Likewise, if the selected activity type is for cleaning and treating water, the task type field 304 can be utilized to specify a series of activities that are to be performed in connection with cleaning and treating water, and that the vendor or other individual is to provide feedback to the platform 150 confirming that the sub-tasks have been performed.

A “form group” field 305 permits a user to select an input form to be utilized in connection with the node. A user may customize the input form according to the specific needs of a site by adding fields requesting desired inputs. A vendor or other individual that is tasked with performing the tasks associated with the node can utilize the form to provide feedback (e.g., to confirm performance of activities, to specify parameters or values associated with performance of the activities, and/or to specify test results and other parameters). The form can be accessed via the logistics management applications 153. In certain embodiments, the form group field 305 can also be utilized to specify that the node is to receive inputs from the equipment (e.g., monitoring equipment 124, remediation equipment 126, and/or sensors 128) at the sites 120 in connection with performing tasks associated with the node.

A “conclusion group” field 306 specifies conclusion parameters, which indicate how the workflow will transition from the node. For example, as mentioned above with respect to FIG. 2, the workflow may transition from test node 203 to one of six different nodes based on the results of the water test (e.g., based on whether the test results fall in different ranges). The conclusion group field 306 may specify the parameters for selecting one of the six nodes based on the test results inputted to the node (e.g., based on the inputs identified or associated with the form group field 305).

A “checkout group” field 307 includes options for indicating statuses when a vendor or other individual is checking out of a node or during completion of the operation at the node. For example, the checkout group field 307 may indicate that the status of the job is to be “completed” or that the individual is “returning” to allow for further actions to be performed in connection with the tasks associated with the node.

A “check-in” field 308 indicates whether an individual (e.g., vendor or employee) is required to check-in prior to or during performance of the tasks associated with the node. For example, if this field is set to “yes,” then the individual may be required to check-in to provide confirmation that the individual will handle the tasks associated with the node.

A “data collection” field 309 indicates whether or not inputs are required to be provided at the node. If this is field is set to “yes” and the form group field 305 identifies an input source (e.g., an input form or equipment inputs), then the node will be configured to receive these inputs.

A “corrective action” field 310 indicates whether or not the node is associated with activities for providing a corrective action. This field can be used to trigger various types of corrective actions. For example, nodes 207 and 210 in FIG. 2 (which are associated with tasks for treating water and cleaning/flushing water towers) can be deemed to be corrective actions.

A “sourcing” field 311 indicates whether vendor sourcing for downstream nodes is permitted (e.g., to ensure time constraints are satisfied). If this field is set to “yes,” this permits vendors or other individuals to be assigned to perform tasks associated with downstream nodes.

A “rescheduling” field 312 indicates whether or not a vendor is permitted to reschedule performance of task for downstream nodes. Thus, if the sourcing field 311 and the rescheduling field 312 are both set to “yes,” then vendors can be sourced for downstream nodes and the vendors are permitted to reschedule performance of the activities.

A “scope of work” field 313 indicates whether or not a scope of work is required for the node. The scope of work can provide a detailed description of one or more tasks associated with the node, and can be utilized by vendors or other individuals in connection with executing or overseeing tasks associated with the node. In certain embodiments, a property manager or other individual can define the scope of work by accessing the platform and inputting associated information.

A “backend job” field 314 identifies another dynamic model 151 that is to be initiated and executed when the workflow transitions to the node. Node 206 in FIG. 2 is an example when the backend job field 314 for a node is set to identify a dynamic model 151 that is directed to activities associated with testing water samples for legionella. When the workflow transitions to node 206, the dynamic model 151 identified by the backend job field 314 will be executed, possibly in parallel with the model to which the node is being added. The backend job field 314 permits a plurality of dynamic models 151 to be linked together in various ways.

A “description” field 315 permits a user to input a textual description describing the node.

A “trigger recurrence on completion” field 316 permits a user to specify that the task associated with the node should once again be triggered upon completion of the task.

An “allow results on behalf” field 317 indicates that an administrator, employee, or other user associated with managing logistics automation platform 150 is permitted to supply inputs (e.g., results, feedback, or data) on behalf of a vendor. Certain tasks may require the vendor to supply the inputs, while other tasks can allow an administrator, employee, or other user to assist a vendor with supplying the inputs. This field allows the user to specify who has the ability to supply the inputs.

An “on behalf requires review” field 318 allows a user to specify whether or not a second administrator, employee, or other user associated with managing logistics automation platform 150 is required to review inputs entered (e.g., results, feedback, or data) on behalf of a vendor.

An “on behalf require vendor confirmation” field 319 allows a user to specify whether or not a vendor is required to confirm the inputs entered (e.g., results, feedback, or data) by an administrator, employee, or other user associated with managing logistics automation platform 150 on behalf of the vendor.

A “default scope of work” field 320 allows a user to specify whether or not a scope of work assigned to, or associated with, the current node is also to be assigned to, or associated with, other nodes or jobs that are spawned by the current node.

A “default project recurrence” field 321 allows a user to specify whether or not the current node will be used as a reference point (e.g., in terms of timing) for a project that is defined by an associated dynamic model 151. In certain embodiments, the first node added to the dynamic model is selected as the default project reference point.

A “job detail report” field 322 allows a user to specify whether or not a report is to be generated that provides details regarding performance of the tasks associated with the node. For example, the job detail report can indicate the types of tasks that were performed, when the tasks were performed, who performed the tasks, results and feedback associated with the tasks, whether or not the tasks were completed, and/or other related information.

A “detail binder class” field 323 allows a user to specify information that can be used to classify a job detail report that is generated. For example, a site report can include information on a wide variety of information (e.g., related to a year-to-date summary, corrective actions, site water testing, monitoring tasks, etc.). The classification information identified by this field can be used to easily identify the appropriate section of the site report in which the job detail report is to be inserted or appended.

A “job history report” field 324 allows a user to specify whether or not a cumulative report (e.g., a cumulative year-to-date summary) is to be generated for jobs or nodes having the same type assigned to the current node.

A “trade” field 325 allows a user to specify the vendor type(s) that is permitted to perform jobs that are associated with the node, or that are spawned from the node.

The exemplary input fields shown on the interface in FIG. 3 demonstrate examples of criteria that can be specified for nodes that are incorporated into the dynamic models 151 created using the logistics automation platform 150. However, it should be recognized that additional criteria can be added to the interface and/or other interfaces may be utilized to define additional characteristics and criteria for the node. In addition, while the interface shown in FIG. 3 includes fields that are primarily directed to adding nodes to a dynamic model 151 associated with managing workflows for legionella conditions, it should be recognized that the interface can be adapted to provide input fields that are utilized to specify criteria for other types of workflows (e.g., workflows associated with IFM obligations and/or other types of chemical/biological obligations).

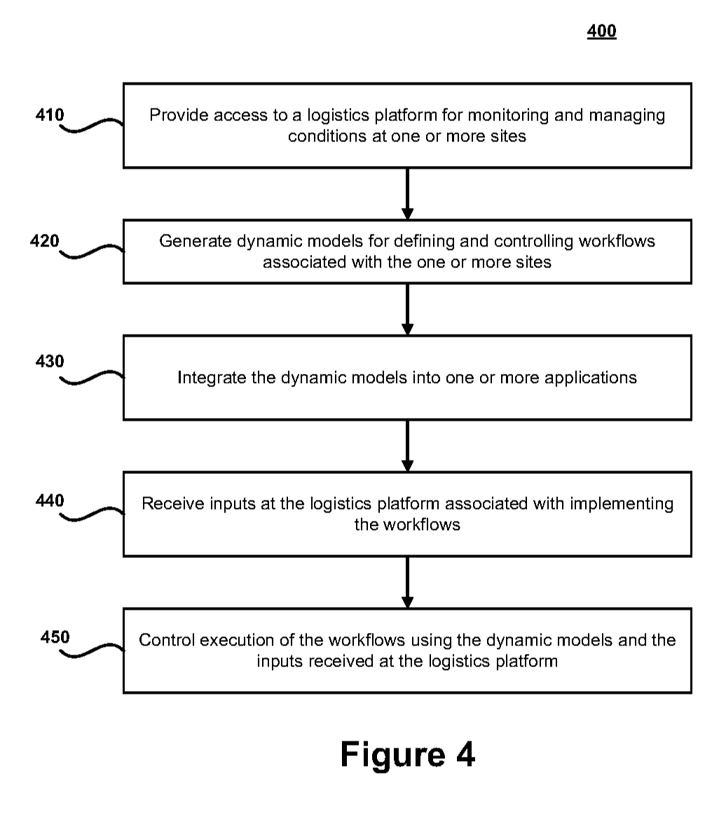

FIG. 4 illustrates a flow chart for a method 400 according to certain embodiments. Method 400 is merely exemplary and is not limited to the embodiments presented herein. Method 400 can be employed in many different embodiments or examples not specifically depicted or described herein. In some embodiments, the steps of method 400 can be performed in the order presented. In other embodiments, the steps of method 400 can be performed in any suitable order. In still other embodiments, one or more of the steps of method 400 can be combined or skipped. In many embodiments, system 100 and/or logistics automation platform 150 can be suitable to perform method 400 and/or one or more of the steps of method 400. In these or other embodiments, one or more of the steps of method 400 can be implemented as one or more computer instructions configured to run at one or more processor devices and configured to be stored on one or more non-transitory memory storage devices. Such processor devices and/or non-transitory memory storage devices can be part of a computer system such as system 100, platform hosting device 130, and/or site servers 122.

In step 410, access is provided to a logistics platform (e.g., logistics automation platform 150) for monitoring and managing conditions at one or more sites 120. The sites may represent residential, commercial, industrial, and/or governmental buildings or properties. The logistics platform can be configured to provide assistance with monitoring, managing, and remediating various types of conditions, such as hazardous biological/chemical conditions or facilities management conditions. In certain embodiments, the logistics platform can be configured to provide assistance with monitoring, managing, and remediating conditions involving legionella at the one or more sites 120. Various individuals (e.g., administrators, platform employees, vendors, property managers, etc.) may be permitted to access the logistics platform using a variety of user devices 110 (e.g., desktop computers, laptop computers, mobile devices, tablet devices, wearable devices, etc.).

In step 420, dynamic models 151 are generated for defining and controlling workflows associated with the one or more sites 120. The dynamic models 151 can be created using modeling tools 152 that are accessible via the logistics platform. In certain embodiments, administrators or individuals associated with hosting the logistics platform can create customized dynamic models 151 for each site 120 to accommodate the specific needs at the sites 120. The modeling tools 152 can provide one or more interfaces that enable the dynamic models 151 to be defined. This can include customizing nodes associated with the dynamic models 151 (e.g., using interface 300 in FIG. 3) and transitions that connect the nodes. Each site 120 can utilize multiple dynamic models 151 to customize workflows for various operations (e.g., workflows for legionella prevention, workflows for IFM specific operations, etc.). In certain embodiments, the dynamic models 151 can be implemented in software and can be stored on the logistics platform.

In step 430, the dynamic models 151 are integrated into one or more applications (e.g., such as logistics management applications 153). Integrating the dynamic models 151 into the one or more applications can include associating the dynamic models 151 with accounts for the sites 120 and/or making the dynamic models 151 available for use with certain accounts. This can be accomplished on the backend of the logistics platform by an administrator or other user. Once a dynamic model 151 is integrated, a user associated with the site 120 can utilize the applications to control a workflow at the site 120 based on the dynamic model 151.

In step 440, inputs are received at the logistics platform associated with implementing the workflows. The inputs may be received from monitoring equipment 124 (e.g., which can include sensors that enable real-time tracking of the hazardous biological or chemical conditions at the plurality of sites) and/or user devices 110 (e.g., which include the applications that enable vendors, administrators, and other users to provide feedback, test results, assessments, and other information related to the conditions at the plurality of sites). The inputs can also be received from remediation equipment 126 (e.g., to indicate the status and/or results of a remediation task). The inputs can be received by the logistics platform over a network 190.

In step 450, execution of the workflows is controlled using the dynamic models 151 and the inputs received at the logistics platform. For example, as a workflow is handled at a site 120, the dynamic models 151 can utilize the inputs to guide the process of handling the workflow. As the workflow is executed, the workflow can transition to specific nodes included in the dynamic models 151. Some or all of the nodes can be associated with specific tasks that are to be carried out and can require certain inputs to be provided to assess the statuses of the tasks and to ensure that tasks are properly carried out.

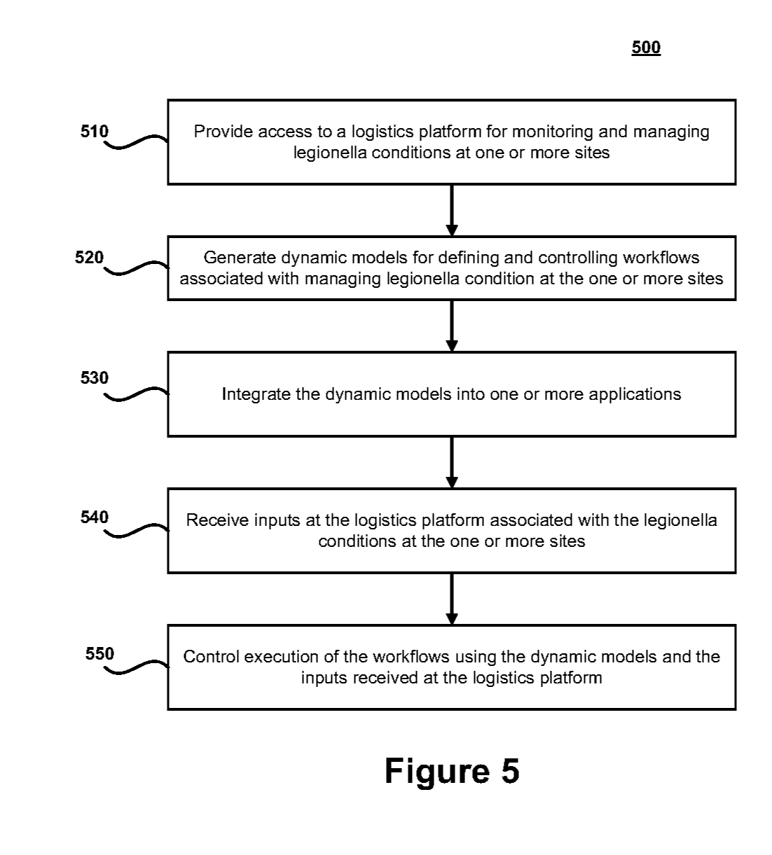

FIG. 5 illustrates a flow chart for a method 500 according to certain embodiments. Method 500 is merely exemplary and is not limited to the embodiments presented herein. Method 500 can be employed in many different embodiments or examples not specifically depicted or described herein. In some embodiments, the steps of method 500 can be performed in the order presented. In other embodiments, the steps of method 500 can be performed in any suitable order. In still other embodiments, one or more of the steps of method 500 can be combined or skipped. In many embodiments, system 100 and/or logistics automation platform 150 can be suitable to perform method 500 and/or one or more of the steps of method 500. In these or other embodiments, one or more of the steps of method 500 can be implemented as one or more computer instructions configured to run at one or more processor devices and configured to be stored on one or more non-transitory memory storage devices. Such processor devices and/or non-transitory memory storage devices can be part of a computer system such as system 100, platform hosting device 130, and/or site servers 122.

In step 510, access is provided to a logistics platform (e.g., logistics automation platform 150) for monitoring and managing legionella conditions at one or more sites 120. Each of the sites can include one or more cooling or water tower structures 121, and the logistics platform can provide assistance with preventing legionella from developing in the cooling or water tower structures 121 and/or eliminating legionella that has developed in the cooling or water tower structures 121. The sites may represent residential, commercial, industrial, and/or governmental buildings or properties. Various individuals (e.g., administrators, platform employees, vendors, property managers, etc.) may be permitted to access the logistics platform using a variety of user devices 110 (e.g., desktop computers, laptop computers, mobile devices, tablet devices, wearable devices, etc.).

In step 520, dynamic models 151 are generated for defining and controlling workflows associated with managing legionella conditions at the one or more sites 120. The dynamic models 151 can be created using modeling tools 152 that are accessible via the logistics platform. In certain embodiments, administrators or individuals associated with hosting the logistics platform can create customized dynamic models 151 for each site 120 to accommodate the specific needs at the sites 120. The modeling tools 152 can provide one or more interfaces that enable the dynamic models 151 to be defined. This can include customizing nodes associated with the dynamic models 151 (e.g., using interface 300 in FIG. 3) and transitions that connect the nodes. Each site 120 can utilize multiple dynamic models 151 to customize workflows for various tasks related to managing the legionella conditions. For example, a first dynamic model 151 can be created to manage operations associated with maintaining the cooling or water tower structures 121; a second dynamic model 151 can be created to manage operations associated with treating the water in the cooling or water tower structures 121; and a third dynamic model 151 can be created for handling situations in which legionella is detected in the cooling or water tower structures 121. Dynamic models 151 can be created for many other types of workflows.

In step 530, the dynamic models 151 are integrated into one or more applications (e.g., such as logistics management applications 153). Integrating the dynamic models 151 into the one or more applications can include associating the dynamic models 151 with accounts for the sites 120 and/or making the dynamic models 151 available for use with certain accounts. This can be accomplished on the backend of the logistics platform by an administrator or other user. Once a dynamic model 151 is integrated, a user (e.g., vendor or property manager) associated with the site 120 can utilize the applications to control a workflow at the site 120 based on the dynamic model 151.

In step 540, inputs are received at the logistics platform associated with the legionella conditions at the one or more sites 120. The inputs may be received from monitoring equipment 124 at the sites 120. For example, one or more of the sites 120 may include monitoring equipment 124 that includes sensors which enable real-time tracking of the legionella conditions at the plurality of sites. For example, the sensors may be used to indicate pH levels of water, water temperature, and/or presence of biological agents. The monitoring equipment 124 can communicate with the logistics platform over a network 190 to indicate whether or not legionella has been detected in the cooling or water towers 121 and/or whether or not conditions are susceptible to developing legionella. The inputs can also be received from remediation equipment 126. For example, one or more of the sites can include remediation equipment 126 that applies biocides, chemicals, and/or other substances to eliminate or prevent the development of legionella in the one or more cooling towers. The remediation equipment 126 can communicate with the logistics platform over a network 190 to provide information related to the substances applied (e.g., to indicate the types of substances applied, the amounts applied, when they were applied, etc.). The inputs can also be received from user devices 110. For example, as tasks are performed at the sites 120 for implementing the workflows, the individuals (e.g., vendors, property managers, etc.) that perform the tasks can provide information to the logistics platform. The information can include feedback, test results, assessments, and/or other information related to the conditions at the plurality of sites 120 or the tasks performed at the sites 120.

In step 550, execution of the workflows is controlled using the dynamic models 151 and the inputs received at the logistics platform. For example, as a workflow is handled at a site 120, the dynamic models 151 can utilize the inputs to guide the process of handling the workflow. As the workflow is executed, the workflow can transition to specific nodes included in the dynamic models 151. Some or all of the nodes can be associated with specific tasks that are to be carried out and can require certain inputs to be provided to assess the statuses of the tasks and to ensure that tasks are properly carried out.

While there have been shown, described and pointed out various novel features of the invention as applied to particular embodiments thereof, it should be understood that various omissions, substitutions, and changes in the form and details of the systems and methods described may be made by those skilled in the art without departing from the spirit of the invention. Amongst other things, the steps in the methods may be carried out in different orders in cases where such may be appropriate. Those skilled in the art will recognize that the particular hardware and devices that are part of the system described herein, and the general functionality provided by and incorporated therein, may vary in different embodiments of the invention. Accordingly, the particular system components are provided for illustrative purposes and to facilitate a full and complete understanding and appreciation of the various aspects and functionality of particular embodiments of the invention as realized in the system and method embodiments thereof. Those skilled in the art will appreciate that the invention can be practiced in ways other than the described embodiments, which are presented for purposes of illustration and not limitation.

What is claimed is:

1. A system for managing hazardous biological conditions at a plurality of sites, the system comprising:
a plurality of cooling or water tower structures located at a plurality of sites;
at least one computing device having at least one processor and at least one physical storage device that stores instructions, wherein execution of the instructions by the at least one processor causes the at least one computing device to:
provide access to a logistics platform that is configured to perform functions associated with monitoring and remediating hazardous biological conditions at the plurality of sites including hazardous biological conditions pertaining to legionella conditions at the plurality of cooling or water tower structures;
generate dynamic models for controlling workflows related to managing the hazardous biological conditions associated with the plurality of cooling or water tower structures;
integrate the dynamic models into one or more applications that are accessible by electronic devices;
receive inputs at the logistics platform from one or more of: monitoring equipment comprising sensors that enable real-time tracking of the hazardous biological conditions at the plurality of sites, or the electronic devices that provide information related to the hazardous biological conditions at the plurality of sites; and
control execution of the workflows associated with monitoring and remediating the hazardous biological conditions using the dynamic models and the inputs received at the logistics platform.

2. A system for managing hazardous biological conditions at a site that includes a cooling or water tower structure, the system comprising:
at least one computing device having at least one processor and at least one physical storage device that stores instructions, wherein execution of the instructions by the at least one processor causes the at least one computing device to:
provide access to a logistics platform that is configured to perform functions associated with monitoring and remediating hazardous biological conditions at the site including hazardous biological conditions pertaining to the cooling or water tower structure;
generate a dynamic model for controlling a workflow related to managing the hazardous biological conditions associated with the cooling or water tower structure;
integrate the dynamic model into one or more applications that are accessible by electronic devices;
receive inputs at the logistics platform from one or more of: monitoring equipment comprising sensors that enable real-time tracking of the hazardous biological conditions at the site, or the electronic devices that provide information related to the hazardous biological conditions at the site; and
control execution of the workflow associated with monitoring and remediating the hazardous biological conditions using the dynamic model and the inputs received at the logistics platform.

3. The system of claim 2, wherein the system further comprises remediation equipment that is configured to cure or prevent the hazardous biological conditions at the site.

4. The system of claim 2, wherein:
the dynamic model includes a node-based diagram that corresponds to the workflow;
the node-based diagram includes a plurality of nodes, wherein at least a portion of the plurality of nodes corresponds to tasks associated with executing the workflow; and
the inputs received at the logistics platform are utilized to control how the workflow transitions among the plurality of nodes.

5. The system of claim 4, wherein:
the logistics platform provides a modeling tool that enables the generation of the node-based diagram; and
the modeling tool is configured to provide one or more graphical user interfaces that enable criteria associated with the plurality of nodes to be specified or updated.

6. The system of claim 4, wherein at least a portion of the plurality of nodes can be configured to initiate execution of one or more additional workflows that are to be executed in parallel with the workflow.

7. The system of claim 2, wherein the inputs received from the monitoring equipment or the electronic devices include information associated with at least one of the following tasks: water testing; cleaning of the cooling or water tower structure; water treatment; or draining or filling the cooling or water tower structure.

8. The system of claim 2, wherein the logistics platform is configured to transmit alerts or notifications for implementing tasks associated with executing the workflow.

9. The system of claim 2, wherein the logistics platform is configured to perform functions associated with monitoring and remediating legionella conditions associated with the cooling or water tower structure.

10. The system of claim 2, wherein the logistics platform is configured to generate reports pertaining to the hazardous biological conditions at the site.

11. A method for managing hazardous biological conditions at a site that includes a cooling or water tower structure, the method comprising:
providing access to a logistics platform that is configured to perform functions associated with monitoring and remediating hazardous biological conditions at the site, including hazardous biological conditions pertaining to the cooling or water tower structure;
generating, with one or more processors, a dynamic model for controlling a workflow related to managing the hazardous biological conditions associated with the cooling or water tower structure;
integrating the dynamic model into one or more applications that are accessible by electronic devices;
receiving inputs at the logistics platform from one or more of: monitoring equipment comprising sensors that enable real-time tracking of the hazardous biological conditions at the site, or the electronic devices that provide information related to the hazardous biological conditions at the site; and
controlling, with the with one or more processors, execution of the workflow associated with monitoring and remediating the hazardous biological conditions using the dynamic model and the inputs received at the logistics platform.

12. The method of claim 11, wherein the method further comprises:
utilizing remediation equipment to cure or prevent the hazardous biological conditions at the site.

13. The method of claim 11, wherein:
the dynamic model includes a node-based diagram that corresponds to the workflow;
the node-based diagram includes a plurality of nodes, wherein at least a portion of the plurality of nodes corresponds to tasks associated with executing the workflow; and
the inputs received at the logistics platform are utilized to control how the workflow transitions among the plurality of nodes.

14. The method of claim 13, wherein:
the logistics platform provides a modeling tool that enables the generation of the node-based diagram; and
the modeling tool is configured to provide one or more graphical user interfaces that enable criteria associated with the plurality of nodes to be specified or updated.

15. The method of claim 13, wherein at least a portion of the plurality of nodes can be configured to initiate execution of one or more additional workflows that are to be executed in parallel with the workflow.

16. The method of claim 11, wherein the inputs received from the monitoring equipment or the electronic devices include information associated with at least one of the following tasks: water testing; cleaning of the cooling or water tower structure; water treatment; or draining or filling the cooling or water tower structure.

17. The method of claim 11, wherein the logistics platform is configured to transmit alerts or notifications for implementing tasks associated with executing the workflow.

18. The method of claim 11, wherein the logistics platform is configured to perform functions associated with monitoring and remediating legionella conditions associated with the cooling or water tower structure.

19. The method of claim 11, wherein the logistics platform is configured to generate reports pertaining to the hazardous biological conditions at the site.

20. A system for managing hazardous biological conditions or facilities management operations at a site, the system comprising:
at least one computing device having at least one processor and at least one physical storage device that stores instructions, wherein execution of the instructions by the at least one processor causes the at least one computing device to:
provide access to a logistics platform that is configured to perform functions associated with monitoring hazardous biological conditions or facilities management operations at the site;
generate a dynamic model for controlling a workflow related to managing the hazardous biological conditions or the facilities management operations;
integrate the dynamic model into one or more applications that are accessible by electronic devices;
receive inputs at the logistics platform from one or more of: monitoring equipment comprising sensors that enable real-time tracking of the hazardous biological conditions or the facilities management operations at the site, or feedback received from the electronic devices that is related to the hazardous biological conditions or the facilities management operations at the site; and
control execution of the workflow associated with the hazardous biological conditions or the facilities management operations using the dynamic model and the inputs received at the logistics platform.
